(19) United States
(12) Patent Application Publication
(10) Pub. No.: US 2009/0179825 A1
(43) Pub. Date: Jul. 16, 2009

(54) ARRANGEMENT FOR PRESENTING AND UPDATING INFORMATION

(76) Inventors: Jukka Enarvi, Tampere (FI); Janne Liimatainen, Tampere (FI); Juhani Virtanen, Tampere (FI); Kari Kyyny, Tampere (FI); Kimmo Ollikainen, Turku (FI); Joakim Uimonen, Turku (FI); Tapani Hyvonen, Turku (FI); Matti Alava, Vantaa (FI)

Correspondence Address: FITCH EVEN TABIN & FLANNERY, 120 SOUTH LASALLE STREET, SUITE 1600, CHICAGO, IL, 60603-3406, US

(21) Appl. No.: 11/816,388

(22) PCT Filed: Feb. 6, 2006
(86) PCT No.: PCT/FI06/50052

§ 371 Date: Mar. 27, 2009

(30) Foreign Application Priority Data
Feb. 17, 2005 (FI) 20050192

(51) Int. Cl. G09G 3/00

(52) U.S. Cl. 345/30

(57) ABSTRACT

The aim of this invention is an arrangement for displaying and updating information with the use of controllable display units, which display units contain at least one display laminate equipped with an essentially thin display which can be updated. The display laminate is arranged for positioning in an essentially transparent pocket-like space, which space also has the ability to contain, in addition to the display laminate, a sheet of paper or a similar sheet or label containing additional information in text or image form.

This invention relates to the arrangement for presenting and updating information defined in the introduction to Patent Claim 1. The arrangement described in the invention can be applied to updating and presenting various kinds of displayed information, including product price details, codes used in warehouses and other kinds of product data. The invention is particularly suitable for application to shops or supermarkets which sell thousands or tens of thousands of products, whose prices must be updated frequently.

In known technology, the price information on supermarket labels is changed manually whenever prices change. New prices are printed out on paper or a similar material and small labels are placed manually in slots reserved for them on the shelves in the shop space. This method involves first finding the correct place for the updated price label, and then removing the old label and destroying it. One problem with this solution is that it is labour-intensive and prone to human error. It also leaves the system open to conflicts between prices on the shelves and prices stored in the scanners at checkouts.

To solve these problems, systems based on LCD technology have been developed in which small LCDs are placed at the front of shelves. These display price information which can be updated from a centralised system control panel or similar device. Solutions in which these LCDs are wired to the central unit have problems in terms of the layout limitations caused by cabling. Similarly, wireless solutions are problematic due to the need for individual power supplies for each LCD, which then must be monitored and changed regularly. This is particularly problematic when there are thousands or tens of thousands of displays, which are difficult to monitor. There is also an environmental problem in disposing of thousands of batteries. Further, both solutions share a problem in the limited viewing angle of LCDs: often the displays must be viewed directly from the front in order to be legible. A further problem is the complexity and cost of the structure and the difficulty of finding faulty devices in time. Another problem is that these fairly thick display devices contain glass, and when placed at the front of shelves, they can easily break from being knocked into with a trolley. If they fall, they become damaged or lost. Further, LCDs must always be sheathed, which causes additional costs.

U.S. Pat. No. 5,537,126 presents a product information display system for use e.g. in shops, applying the abovementioned LCD-style display units, although the patent mentions that other types of displays may be used. The displays receive their power and the necessary information through induction from conductors placed in proximity to the display labels. The conductors are wired to a central unit and power supply. In order to work, the inductive data and power transfer process requires a lot of complex electronics in each display, including a microprocessor. The problem with this system is that the display is relatively large, expensive and prone to breaking. There are also limitations caused by the wires and the small angle of view of the LCDs. Further, the displays, which are essentially thick, require a specially manufactured, strong shelf rail system which is different from the one commonly used with paper labels. This means that structural modifications must be made to existing shelves.

European Patent no. EP 1110138 B1 presents a thin, flexible, electronic label which can also be used as a price label. Primarily the labels are meant for attaching directly onto products. Each label has its own antenna for receiving price information and the necessary equipment for updating and displaying price information. The labels do not need a power supply. The problems with this solution are the complexity of the structure and the antenna solution, which has to be installed in each separate label. This increases the cost of the labels, as well as their susceptibility to faults. Thinking of the price label system as a whole, individual labels which are attached directly onto products do not provide a kind of flexible and well-functioning arrangement in which the price information on the labels could be updated centrally.

The aim of this invention is to eliminate the problems described above and to create an affordable, simple and reliable arrangement for presenting and updating information, using thin and flexible display laminates which can easily be applied in combination with paper labels or sheets containing price information. The invention also aims to create a simple and variable display laminate, which is durable in many different situations and in which the same basic structure can be applied to multiple uses. The aim of the invention is also to create a thin, elastic and flexible display laminate, whose outer appearance is very similar to the commonly used price labels made of thin paper or a similar material. The arrangement described in the invention is characterised by the factors listed in the characteristics section of Patent Claim 1. Other applications of the invention are characterised by the factors listed in the other Patent Claims.

The benefit of the invention lies in the resistance of such thin and flexible display laminates against blows, as well as the small space required, which means that they are not prone to being hit with shopping trolleys or to things sticking to them. Further, the thin display laminates are very similar to the ordinary price labels which are commonly in use, so the arrangement described in the invention would not require great changes in the appearance of the space where they are used or in the structure of the shelves. A further benefit is the fact that paper sheets or labels containing product information or other suitable details can be placed in the same pocket or space as the display laminate, as the thickness of the laminate does not exceed that of paper by much. A further benefit is the versatility of the solution. The same basic structure can be used for laminates of various different sizes and purposes. A further benefit is the freedom of placement of the laminates, as there are no fixed connections to a central unit or power supply. A further benefit is the fact that information to be updated, such as the new price of a product, is easy to feed centrally to the laminates, which saves a lot of time and effort and reduces the risk of human error. A further benefit is the low consumption of power: only a few batteries are needed for power supplies and they are long-lasting, as in practice the laminates only use power when they are being updated. After that, the updated information stays visible without the need for power input.

Below, the invention is described in detail using application examples, by referring to the appended figures, in which

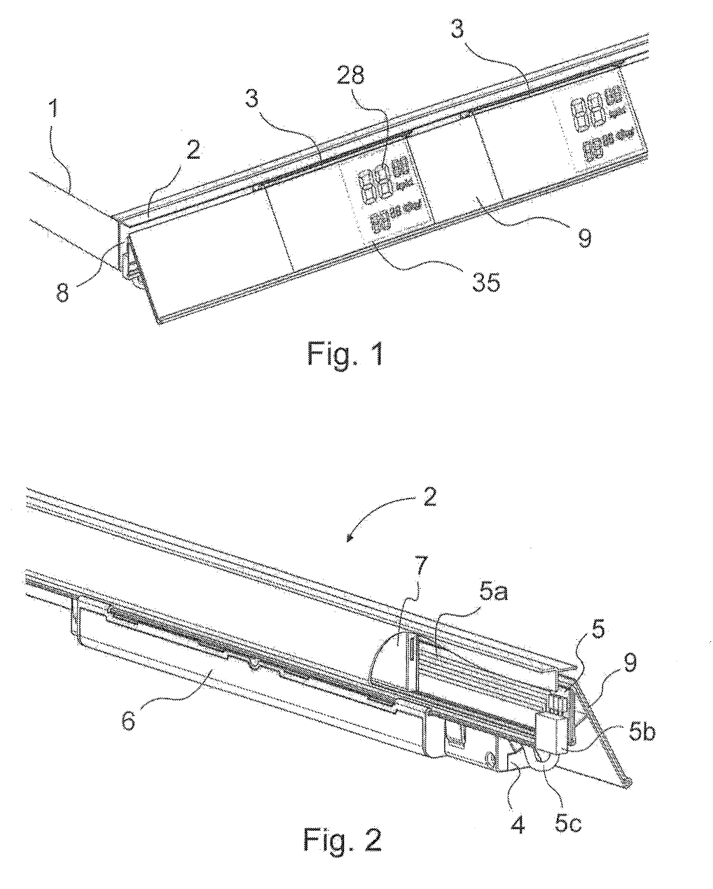

FIG. 1 shows a simplified diagram of an arrangement in accordance with the invention, in which display laminates are placed on the edge of a shelf, viewed at an angle from the front,

FIG. 2 shows the arrangement described in FIG. 1, viewed at an angle from the back,

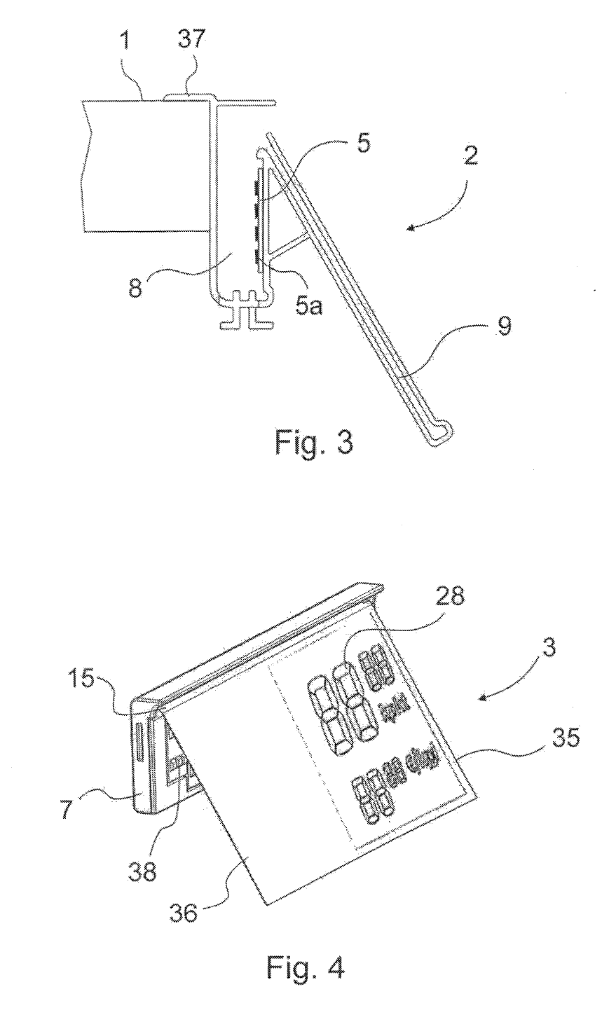

FIG. 3 shows the shelf rail described in FIG. 1, viewed from the end,

FIG. 4 shows a display unit in accordance with the invention, made to fit with the shelf rail described in FIG. 3, viewed at an angle from the front,

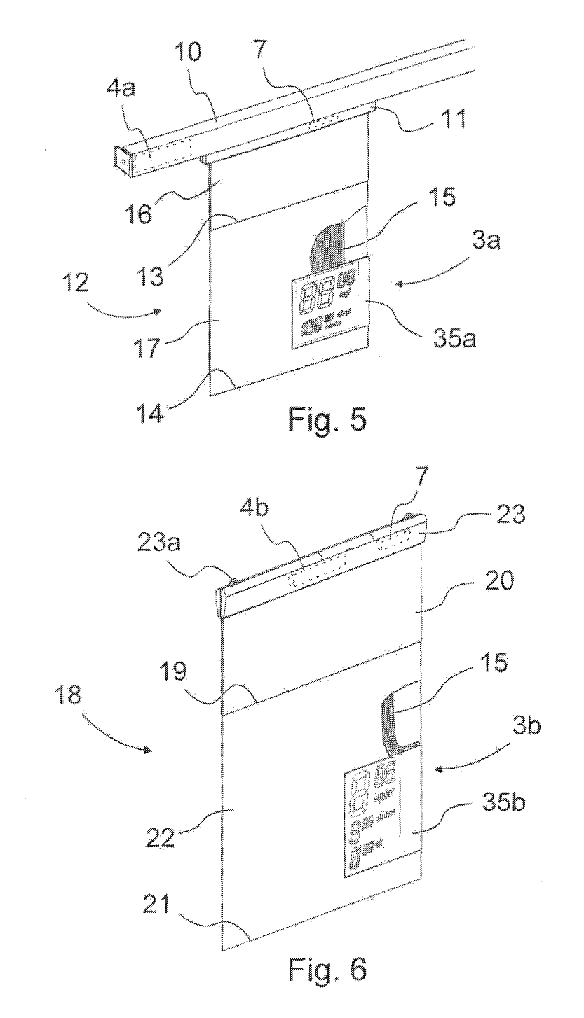

FIG. 5 shows another arrangement in accordance with the invention, in which the display unit is placed in a display pocket hung from a rail placed above the product, viewed partially as a cross-section and at an angle from the front,

FIG. 6 shows a third arrangement in accordance with the invention, in which the display unit is placed in a display pocket hung from a rail placed above the product, viewed partially as a cross-section and at an angle from the front,

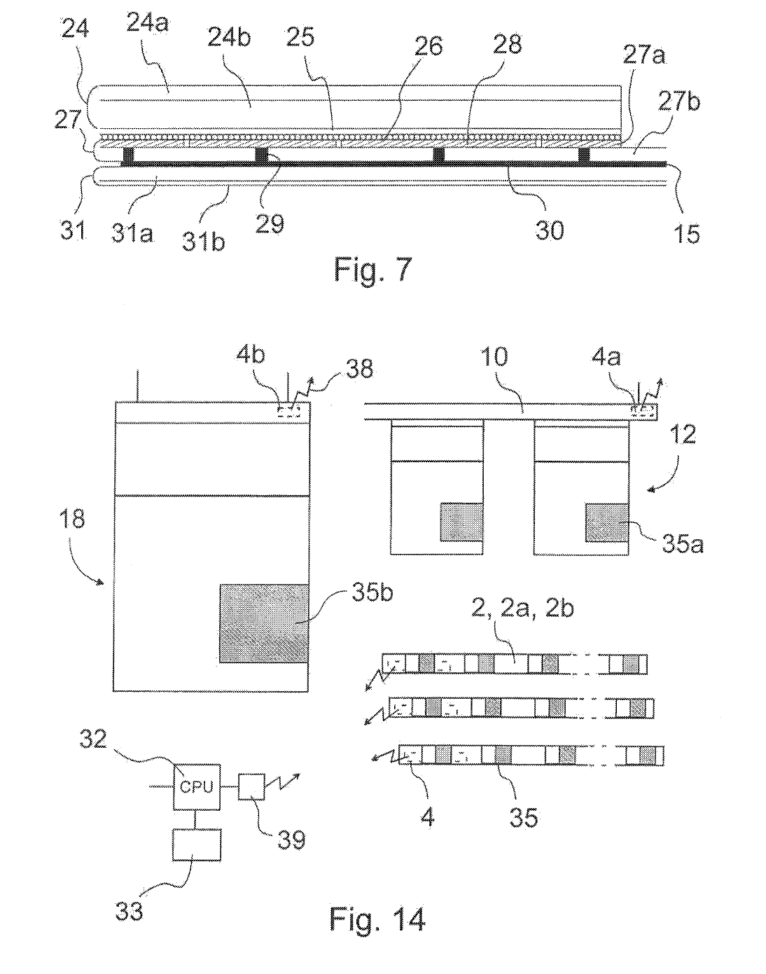

FIG. 7 shows one of the applicable layer structures of the display laminate described in the invention, enlarged and simplified,

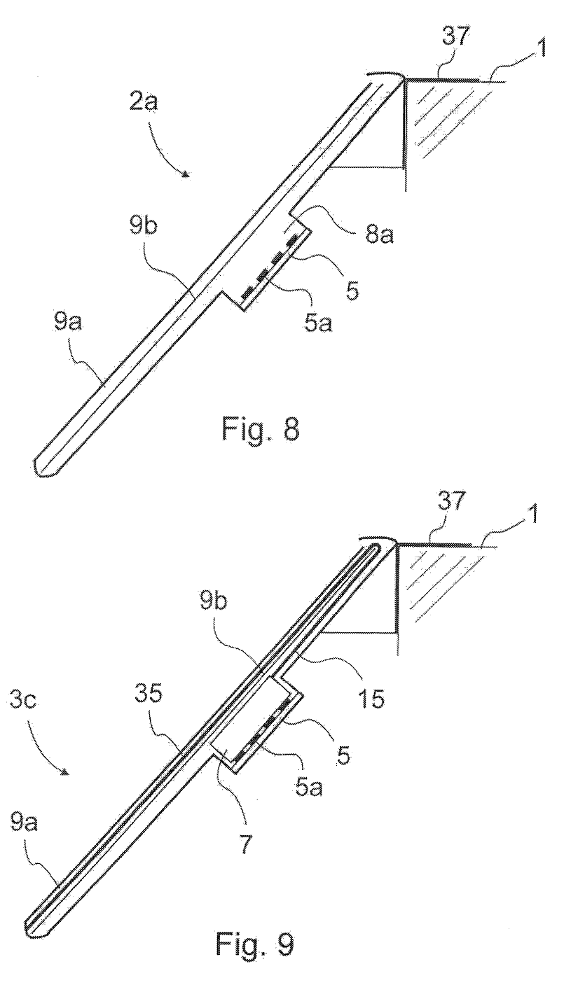

FIG. 8 shows the shelf rail used in a preferred application, viewed from the end,

FIG. 9 shows a shelf rail as described in FIG. 8, equipped with a display unit in accordance with the invention, viewed from the end,

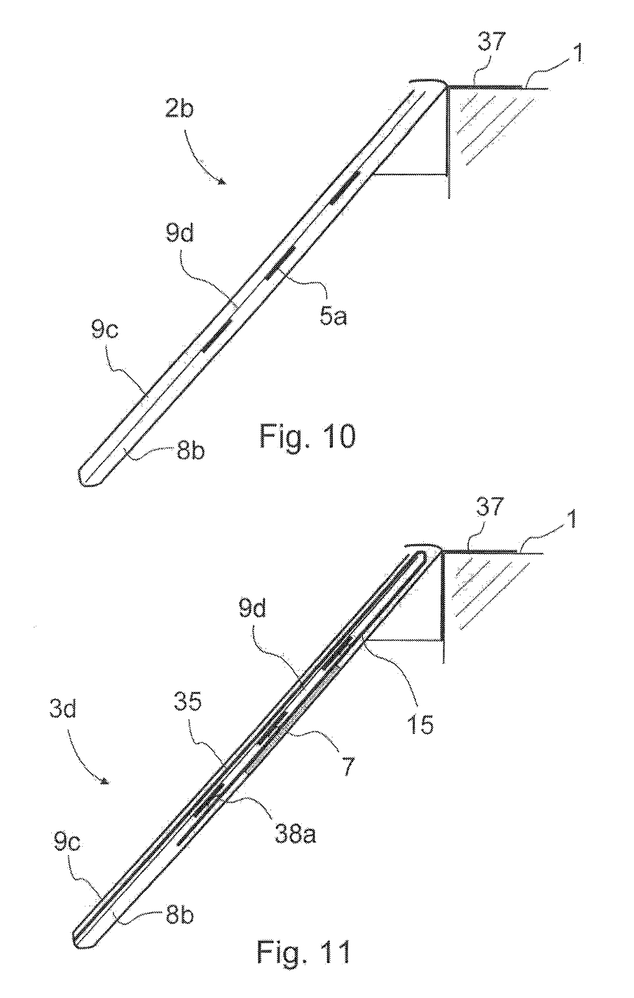

FIG. 10 shows the shelf rail used in another preferred application, viewed from the end,

FIG. 11 shows a shelf rail as described in FIG. 10, equipped with a display unit in accordance with the invention, viewed from the end,

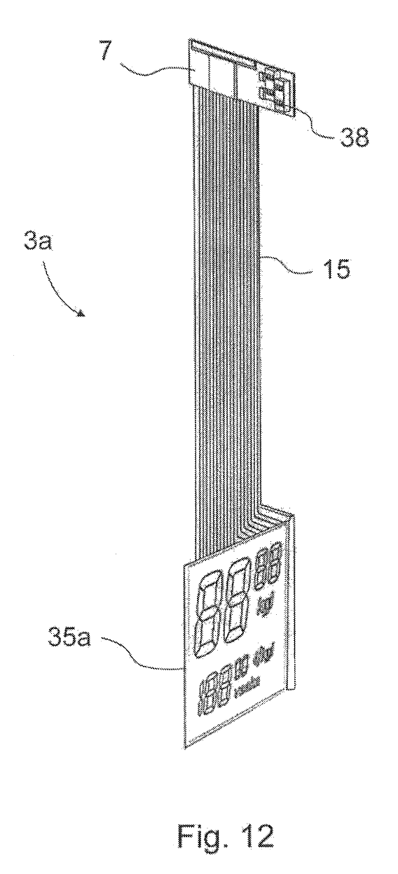

FIG. 12 shows a display unit-with a hanging structure, viewed partly in a cross-section and at an angle from the front,

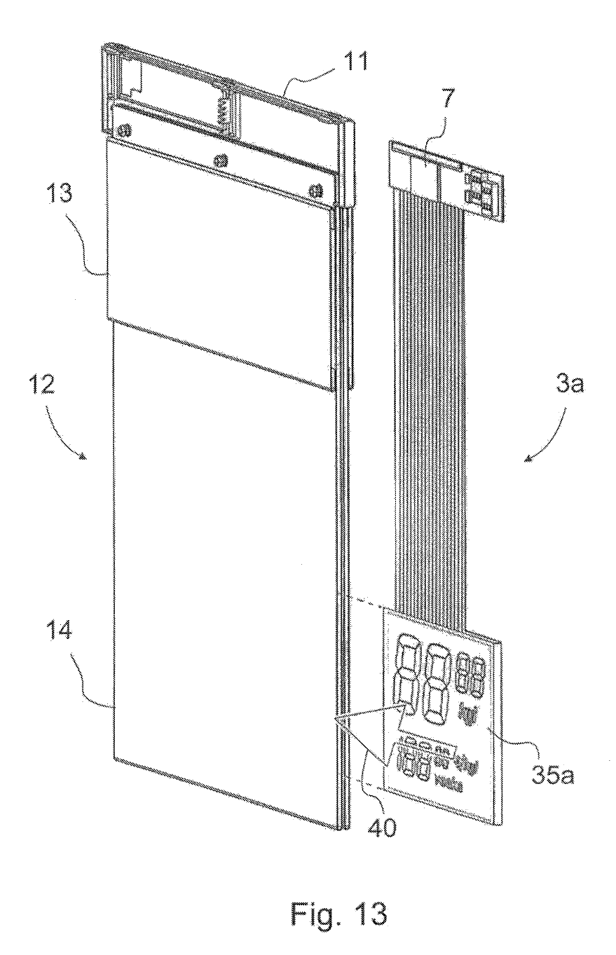

FIG. 13 shows the display pocket unit of a hanging structure in more detail and the placement of a display unit in this pocket unit, viewed at an angle from the front, and

FIG. 14 shows the arrangement in accordance with the invention, placed in a supermarket or similar sale environment, in diagrammatic and simplified form.

One of the basic principles behind the invention is to replace the commonly used price label systems consisting of thin paper labels with a label system that is essentially as similar to the paper label system as possible, in order to essentially maintain the structure and appearance of current shelves as unchanged as possible. This is done using thin, essentially flexible, laminated price labels, which carry product price information which can be updated centrally and remotely, e.g. from a central control unit or similar device. Although a price label system is below described in more detail as an application of the information display and updating system made in accordance with the invention, the invention is not limited to label systems. Instead, similar display units and display laminates can be used in various different applications, for instance warehouses.

FIGS. 1 and 2 show one arrangement in accordance with the invention, in which display units (3), equipped with essentially thin and flexible display laminates (35), are freely placed sideways into their places on a shelf rail (2), manufactured out of plastic into the correct shape. Each display laminate (35) forms a price label, similar in appearance to a paper label, equipped with display segments (28) on which the necessary product price information and other markings are displayed by changing the colour of the essentially dichromatic display segments (28). The shelf rail (2) is attached to the front of a product shelf (1) in a similar arrangement to that used in systems which apply traditional paper labels. The display laminate (35) on the display unit (3) is located in the front space (9) of a transparent, pocket-like protective sheath located at the front of the shelf rail (2). A display driver (7), which drives the display segments (28), is located in a rear space (8) forming a support casing, located at the back of the shelf rail.

In addition, FIGS. 1 and 2 show a control unit (4), which is attached through shape locking or another suitable method to the underside of the shelf rail (2) that is furthest to the edge of the product shelf (1). The control unit (4) contains a control part as well as a power supply and receiver equipment in the form of a radio, infrared, bluetooth or similar receiver.

The power supply may consist for instance of ordinary batteries, whose useful life will be long due to power only being used during the updating process. In addition, connected to the control unit (4) and placed in the casing (8) lengthwise along the shelf rail (2), there is an open conductor (5) containing a suitable number of wires (5a) for transmitting the necessary control and power data between the control unit (4) and the display driver (7) in the display unit (3). At one end of the open conductor (5) is a connector (5b), to which wires (5a) are connected. Through the connector (5b), the open conductor (5) is connected to the control unit (4) or to the open conductor (5) of the next shelf rail (2) through a connecting cord (5e).

FIG. 3 shows one kind of shelf rail (2) made in accordance with the invention, viewed from the end, attached to the front of the shelf (1). At the back of the shelf rail (2) there is a bracket (37), which points outwards and is attached to the top of the front edge of the shelf (1) e.g. with double-sided tape, when the shelf rail (2) is assembled and put in place. At the back of the shelf rail there is a pocket-like support casing (8), to the inside of which is attached an open conductor (5) the same length as the shelf rail (2) e.g. with double-sided tape placed on its back side, when the shelf rail is assembled and put in place. Thus the wires (5a) of the open conductor (5) point towards the back of the shelf rail. The front edge of the casing (8) is lower than its back edge, so that the display unit (3) and its control conductors (15) can be placed inside the casing. A pocket-like protective capsule (9), which is also essentially the same length as the shelf rail, starts from the top of the front edge and points downwards at an angle. The space inside the pocket-like protective capsule is measured to suit the thin, flexible display laminate (35) of the display unit (3), which is placed inside the pocket-like protective capsule (9) during installation. In addition, the pocket-like capsule can contain a paper or card label printed with product information or other suitable details, either next to the display laminate (35) or partially overlapping with it.

FIG. 4 shows a display unit (3) suitable for use with the shelf rail (2) described in FIG. 3, consisting of a thin display laminate (35) and a display driver (7) connected to each other with short, flexible control conductors (15) and folded to the correct angle together. The display laminate (35) consists of two parts in that a thin backing is integrated to the display laminate (35), by the side of the display segment (28). A paper label (36) containing product or other information can be placed on top of this backing. The paper label (36) can be placed on top of the backing without attaching it, so that the paper label (36) stays in place within the pocket-like capsule (9) of the shelf rail (2). Alternatively, the paper label (36) can also be glued to the backing next to the display laminate (35). The backing can also include a transparent pocket-like part, into which the paper label (36) containing product information can be inserted.

The display laminate (35) includes display segments (28), which can be updated at least with the product's unit price, price per kilogram or a similar comparative price and other necessary details. The display laminate (35) has control conductors (15) which are connected at one end to the display segments (28) of the display field, and at the other end to the display driver (7) of the display unit (3). In addition, the display driver (7) has connectors (38) through which the display unit (3) is connected to the wires (5a) of the open conductor (5). The connectors (38) can be e.g. SIM connectors of the sort used in telephones, or other similar connectors.

FIG. 5 shows an essentially right-angled display pocket unit (12) equipped with a display unit (3a), hung from a supporting rail (10) placed above the product. Preferably, the display pocket unit (12) should be approximately the same size as a commonly used sheet of paper. One typical size standard is an A4-sized display pocket unit. The display pocket unit (12) consists at least of a connector rail (11) and a plastic pocket-like casing (14) into which an A4-size sheet of paper or a similar material (17), containing various kinds of printed information and pictures related to the product, can be inserted. In addition, another plastic pocket-like casing (13) can be placed at the top edge of the display pocket unit (12) for inserting a paper sheet to display e.g. the shop's name or other similar information. Casings 13 and 14 are attached at their top edge to the connector rail (11) such that the abovementioned paper sheets can be inserted into them from the top. In addition, the connector rail (11) holds the display driver (7) for display unit 3a, which is functionally comparable to the display driver (7) for display unit 3, described above. The connector rail (11) with its display driver is hung onto a support rail (10), onto which several similar display pocket units (12) can be hung. The support rail (10) holds control unit 4a, which contains similar devices as control unit 4 for shelf rail 2, which devices are meant for receiving data and feeding data and power to the display laminates (35a) on the display units (3a), which are hung off the support rail. All the display units (3a) for the display pocket units (12) hung off the same support rail (10) are connected to the same control unit (4a).

Display laminate 35a for display unit 3a is structurally and functionally essentially similar to display laminate 35 for display unit 3 used on product shelf 1, but it could be larger in size. In addition, the control conductors (15) connecting the display laminate (35) to the display driver are longer than the shelf in this solution. Parallel control conductors (15), placed in a banded structure, start from the side of the display laminate (35a) so that once installed, the control conductors (15) can be folded vertically to the back of the display laminate (35a). Then the control conductors (15) go past the A4-sized paper sheet (17) placed in the casing (14) to the back of the paper sheet and are thus hidden by the paper sheet as they go up. The display pocket unit (12) can be double-sided, e.g. by making the back side the mirror image of the front side. This double-sided solution can house two A4-sized paper sheets (17), in between which the control conductors (15) can be hidden.

FIG. 6 shows an independent, essentially right-angled hanging display pocket unit (18), equipped with a display unit (3b). The display pocket unit (18) should preferably be of A3 or A2 size, or the size of another suitable, commonly used, relatively large paper sheet standard. This display pocket unit (18) incorporates similar plastic pocket-like casings (19 and 21) as those described for display pocket unit 12, except in a larger size. Casing 21 can contain an A3 or A2-sized paper sheet or brochure (22) and casing 19, which is optional and could be left off, can contain a paper sheet or brochure (20) the same width as an A3 or A2 sheet but of a different height, comparable to the parts described for display pocket unit 12. Casings 19 and 21 are attached at their top edge to a connector rail (23) such that the abovementioned paper sheets (20 and 22) can be inserted into them from the top. The connector rail is equipped with hanging loops (23a) and placed at the top edge of the display pocket unit (18). In addition, the connector rail (23) holds the display driver (7) for the display pocket unit (18), which is functionally comparable to the other display drivers (7) described above.

The connector rail (23) also holds a control unit (4b), which has similar devices to those of control unit 4, with communication equipment and a power supply for receiving data and sending it on to the display laminate (35b). For double-sided display pocket units, the control unit (4b) is meant to be shared by both display units (3b). The display pocket unit (18) with its casings (19, 21), and display unit 3b with its display laminate 35b and control conductors 15 are structurally and functionally essentially similar to display pocket unit 12 and display unit 3a, with its display laminate 35a and control conductors 15.

FIG. 7 shows an applicable layer structure for display laminates 35, 35a and 35b, enlarged and simplified. The figure is not to scale, and neither are the thicknesses of the different layers, necessarily. The outer layer is an essentially transparent protective laminate layer (24) which consists at least of a thin, protective surface laminate (24a) over a polyester (PET) film layer (24b). On the underside of the PET layer (24b) is an essentially transparent, electrically conducting layer (25), which could consist for instance of indium tin oxide. On the underside of the electrically conducting layer (25) is an active ink layer (26), whose underside has a thin layer of adhesive. The active ink layer (26) consists of known technology, with several liquid-filled microcapsules containing e.g. positively surface charged, essentially black particles, and negatively surface charged, essentially white particles, whose placement within the microcapsules is controlled with an electric field such that for the desired display segments (28) the black particles are at the top—in which case the display segments look black when viewed from the top—while for other display segments (28) the white particles are at the top—in which case the display segments appear lighter in colour. The background of the display consists of the same microcapsules, so for instance price data can be displayed as dark numbers against a light background or vice versa.

The colours of the display can be varied by using particles of different colours and/or liquid of different colours in or around the microcapsules. The microcapsules can also be filled just with monochromatic particles with either a positive or negative surface charge. In this case, the electrically charged particles can be directed either to the viewer-side edge or the opposite edge of the microcapsules by changing the direction of the electric field, which means that viewers will see segments which are the colour of the particles and segments which are the colour of the liquid in the microcapsules.

Attached to the layer of adhesive is a metal-PET layer (27), above which is an electrically conducting metal layer (27a) consisting e.g. of copper, into which the necessary display segments (28) have been etched for showing numbers, other characters and a background. Below the metal-PET layer (27) is a PET layer (27b) into which access perforations (29) have been drilled using laser-beam drilling. Each access perforation (29) is linked to a separate display segment (28) on the copper layer. The ends of the control conductors (15) are printed onto the underside of the PET layer (27b) with electrically conducting ink (30) such that the ends of the wires (15) are connected through the access perforations (29) to the display segments (28) on the copper layer so that the end of each wire (15) is in contact with only one segment (28). On the underside of the electrically conducting ink layer (30) there is a protective laminate layer (31) equipped with a thin layer of adhesive and consisting of a PET layer (31a) on top and a thin aluminium layer (31b) underneath. The protective laminate layer (31) is adapted to protect the whole display laminate (35, 35a, 35b) structure from mechanical wear and moisture. The film formed by the PET layer (27b), the parallel control conductors (15) consisting of electrically conducting ink (3) and the protective laminate layer (31) continue away from the display laminate to the display driver (7) in the form of a thin, flexible band. When necessary, the display laminate can also include other kinds of protective and adhesive layers.

The display segments (28) in the display laminate (35, 35a, 35b) are controlled with the use of an electric field so that by transferring an electrical charge in between the electrically conducting layer (25) and the desired display segment (28) with the use of the control conductors (15), an electric field is formed in the space of the desired display segment (28) between the conducting layer (25) and the display segment (28). This is done to direct the surface-charged black and white particles in the microcapsules of the active ink layer (26) at the desired display segment (28) to the necessary positions to make the display segment (28) in question appear dark. Depending on the direction of the electric field at the display segments (28), some display segments (28) appear dark and some light. When the electric current is switched off, the active ink layer (26) maintains the patterns formed in the display segments (28) with the help of the electric field, without a need for further electrical power. The pattern will not change until the next update is carried out with a new electric field.

The display laminate has a thin, flexible laminate structure consisting of essentially thin layers. In the example described here, the thickness of the protective surface laminate layer (24b) is typically approx. 100 μm, although it could be thicker, preferably between 100 and 300 μm. Similarly, the thickness of the PET layer (24b) is, in the structure according to the example, typically approx. 200 μm, although it could be thicker, up to approx. 600 μm. Here the thickness of the electrically conducting layer is typically less than 1 μm, and the thickness of the active ink layer is approx. 70 μm. The thickness of the electrically conducting metal layer (27a) is, in the structure according to the example, typically 18 μm, and the thickness of the PET layer (27b) is approx. 50 μm. Further, the thickness of the conducting ink layer is 10 μm in the structure described here. The protective laminate layer (31) that is furthest down in the structure is not needed in all cases. If this layer is, however, added to the structure, its thickness could vary between 100-300 μm, typically being 100 μm. Thus, the total thickness of the display laminate (35, 35a 35b) is typically a few hundred micrometres, e.g. less than 600 μm. In all cases, the thickness of the display laminate should essentially be less than 1 mm.

FIG. 8 shows one kind of shelf rail (2a), made out of extruded plastic in accordance with one preferred application of the invention, viewed from the end, attached to the front of shelf 1. In this application, the back section of the shelf rail (2a) forms a space (8a) which is open at the front and acts as a support casing, onto the back wall of which the open conductor (5) can be attached e.g. with double-sided tape. At the front of the shelf rail (2a) there is a front space (9a), which acts as a pocket-like casing and is similar to pocket-like casing 9. Further, the pocket-like casing (9a) contains a protective strip (9b), which is essentially nearly as high as the pocket-like casing and is designed to separate the support casing (8a) and the front space of the pocket-like casing (9a) from each other.

FIG. 9 shows a shelf rail (2a) in accordance with FIG. 8, inside which a display unit (3c) similar to display unit 3 is placed so that the display laminate (35) of the display unit is inside the pocket-like casing (9a), in front of the protective strip (9b), and the control conductors (15) pass above the protective strip (9b) to the back of the protective strip. A display driver (7) is placed into the support casing (8a) so that the connectors of the display driver are in contact with the wires (5a) of the open conductor (5).

FIG. 10 shows a shelf rail (2b), made out of extruded plastic in accordance with another preferred application of the invention, viewed from the end, attached to the front of shelf 1. In this application, at the front of the shelf rail (2b) there is a front space (9c), which acts as a pocket-like casing and is similar to pocket-like casing 9. Further, the pocket-like casing (9c) includes a rear space (8b) and a protective strip (9d), essentially nearly as high as the pocket-like casing where the protective strip is designed to divide the pocket-like casing (9c) into two sections. The wires (5a) are attached either directly by pressing or with tape to the back surface of the protective strip (9d) so that they point towards the rear space (8b), in order to connect the display units (3d) placed on the shelf rail (2b) to the control unit (4).

FIG. 11 shows a shelf rail (2b) in accordance with FIG. 10, inside which a display unit (3d) similar to display unit 3 is placed so that the display laminate (35) of the display unit is inside the pocket-like casing (9c), in front of the protective strip (9d), and the control conductors (15) and a small, flat control driver (7) pass above the protective strip (9d) to the back of the protective strip in the rear space (8b) so that connectors (38a) of the display driver (7) are in contact with the wires (5a).

FIG. 12 shows a display unit (3a) to be placed inside the display pocket unit (12) with the display laminate (35a) partially folded open in order to show the structure of the display unit (3a) more clearly. Display unit 3b, placed in the larger display pocket unit (18), is essentially analogous to display unit 3a, except that it is typically larger in size.

Similarly, FIG. 13 shows in more detail the display pocket unit (12) of the hanging structure and the placement of the display unit (3a) in the display pocket unit (12) at the assembly stage. The display laminate (35a) of the display unit (3a) is folded in half along a vertical axis towards the control conductors (15), and the display unit (3a) is slipped into the pocket-like casing (14) sideways as shown by the arrow (40). An A4-sized sheet of paper or a similar material (17), which completely covers the control conductors (15) is slipped in from the other edge of the casing in a direction opposite to that of the arrow (40) so that the sheet of paper ends up in between the display laminate (35a) and the control conductors (15), behind the display laminate (35a), but covering the control conductors (15). The order of the assembly process can also be modified so that the paper sheet (17) is placed into the casing (14) first, after which the display unit (3a) is inserted. The display laminate (35a) can also be placed in a separate pocket at the front of the casing (14). The larger display pocket unit (18) is, with the exception of the more detailed structure of the connector rail (11), essentially analogous to display pocket unit 12, except that it is typically larger in size.

FIG. 14 shows the arrangement in accordance with the invention, placed in a supermarket or similar sale environment, in diagrammatic and simplified form. Shelves (1) are equipped with shelf rails (2, 2a, 2b), inside which display units (3, 3c, 3d) equipped with display laminates (35) are placed in locations corresponding to the products on the shelves. At the end of the shelf rail (2, 2a, 2b) closest to the edge of each product shelf (1) there is a control unit (4), which transmits data to the display units (3, 3c, 3d) along the whole shelf. At the same location, the shelf rails (2, 2a, 2b), which are shorter than the shelf (1), and the open conductors (5) are connected, so only one control unit (4) is needed for each product shelf (1). Similarly, hanging display pocket units (12, 18) are placed in suitable locations around the sale space. The system also includes at least a control centre (32) equipped with a communicating device (39) such as a radio, infrared, bluetooth or similar transmitter, through which the data to be updated are sent to the control units (4, 4a, 4b).

In addition, the scanners (33) which scan the price of each product at the checkouts can be connected to the system, which means that the same, up-to-date price information is contained in the scanners and on the display units. The control centre (32) can also be connected to other control and support systems. The wireless connection between the control centre (32) and the control units (4, 4a, 4b) is described with arrows (38).

In the arrangement according to the invention, the number displays on the display laminates (35, 35a, 35b) of the display units (3, 3a, 3b, 3c, 3d) are updated centrally using the control centre (32) or other similar equipment. Each display unit (3-3d) is identified by its own identification code. The ID codes of the desired display units and the new prices are fed into the control centre (32) or into an input device connected to it and transmitted through a wireless connection to the control units (4, 4a, 4b), with the help of which the information regarding a price change is directed to the correct display unit's display driver (7). Depending on the information contained in the control signal, an electric current is sent selectively to the control conductors (15) connected to the display unit's display laminate (35, 35a, 35b) so that the electric field which is formed changes the data in the display laminate's number field as required by changing the colour of the display segments (28). When the updating has been done, the electric current is cut off from the control conductors (15) and the display laminate is left in its updated state without any power.

Those skilled in the art will clearly see that the invention is not limited to the application examples given above, but can be varied within the scope of the patent claims given below. For instance the connection between the control centre and the display units' control units could also be wired.

It will also be obvious to those skilled in the art that the structure and shape of the display laminate can vary from the descriptions given above. The active display material could consist of another electrophoretic material or of a display consisting of rotating dichromatic particles. The display material could also be an electrochromic or liquid crystal material, or the display laminate could be created out of light-emitting display materials such as electroluminescent displays or organic light emitting diodes (OLEDs). Generally speaking, any display materials which can be used to create thin, paper-like displays are suitable for use in the invention. The most essential aspect is that a thin, paper-like, integrated display laminate is used for instance for displaying price information, and that printed information is easy to display close to the display laminate. In addition, the information on the display laminate can be updated electronically.

Further, it will be obvious to those skilled in the art that the display driver can be significantly smaller than that described above, and it can be integrated directly onto the back of the display laminate which eliminates the need for long display driver conductors.

It will also be obvious to those skilled in the art that instead of display segments of a certain shape and instead of the segment control process, matrix displays can be used which are controlled by a matrix controller. In this case, instead of individual display segments, there would be several small matrix-shaped elements which are controlled with the matrix control principle, such that there is only one control conductor and one driver for each row and column of elements. In order to update the displayed information, electricity is conducted to the desired matrix elements, changing the state of the active display material at those elements. The term “display element” will be used collectively to signify matrix elements and display segments below in the patent claims.

1. An arrangement for displaying and updating information with the use of controllable display units, which display units contain at least one display laminate equipped with a display which can be updated, wherein the display laminate is arranged for positioning in an essentially transparent pocket-like space, which space also has the ability to contain, in addition to the display laminate, a sheet of paper or a similar sheet or label containing additional information in text or image form.

2. An arrangement in accordance with claim 1, wherein the control conductors of the display laminate are bent out of sight, concealed at least partly by the display laminate.

3. An arrangement in accordance with claim 2, wherein the control conductors of the display laminate placed in a hanging display pocket unit are, when in use, bent behind the display laminate, and wherein a sheet of paper or a similar sheet is placed in between the display laminate and the control conductors, concealing the control conductors.

4. An arrangement in accordance with claim 3, wherein the hanging display pocket unit contains at least a connector rail, to which at least one essentially transparent plastic pocket-like space is attached by its top edge, which transparent space contains both the display laminate with its control conductors and a sheet of paper or a similar sheet containing product information in text or image form.

5. An arrangement in accordance with claim 4, wherein the hanging display pocket unit further comprises a second, essentially shorter, transparent pocket-like space, which is placed essentially on the upper section of the display pocket unit, which second space can contain a sheet of paper or a similar sheet containing logos or names in text or image form.

6. An arrangement in accordance with claim 3, wherein in that the display drivers of the display units placed inside the hanging display pocket unit are connected with conductors to a control unit.

7. An arrangement in accordance with claim 1, comprising at least a shelf rail attached to the edge of a product shelf, which shelf rail contains at least an essentially narrow front space for inserting the display laminate of the display unit as well as a separate paper label containing product information in text or image form, and a rear space located behind the front space, which rear space is intended to contain the display driver for the display laminate.

8. An arrangement in accordance with claim 7, comprising connected to the shelf rail, at least a control unit for the display laminates and an open conductor equipped with wires, as well as a number of display units, such that the display drivers for the display laminates are connected to the control unit with the use of an open conductor.

9. An arrangement in accordance with claim 1, wherein the display unit is equipped with a thin, essentially transparent pocket-like space placed next to the display space of the display laminate, in order to display additional information in printed format on paper, or in another suitable form, to complement the information displayed on the display laminate.

10. An arrangement in accordance with claim 9, wherein the display laminate is essentially thin and comprises layers of varying thicknesses, which layers include at least a protective laminate layer, underneath which is an electrically conducting layer, underneath which is an active display material layer, underneath which is an electrically conducting layer containing display elements, underneath which is a PET layer or similar layer equipped with access perforations, onto the underside of which the ends of the control conductors are printed with conducting ink.

11. An arrangement in accordance with claim 10, wherein the access perforations are positioned such that there is only one perforation by each display segment, and the end of each control conductor passes through one access perforation to touch one display segment.

12. An arrangement in accordance with claim 1, wherein the information to be updated is arranged for being transmitted as a control signal through a control centre to control units located close to the display units, with which control units an electric current is selectively connected to display elements in the display laminates of the display units in accordance with the information contained in the control signal, to update the information displayed on the display laminates in accordance with the control signal through the electrical effect on the display laminates, and the electrical current is switched off from the display units after the updating event.

13. An arrangement in accordance with claim 12, wherein each display unit is equipped with a display driver to control each display segment or each matrix element row and column of the display laminate individually, which display driver controls the electrical current so that it is switched on selectively for the updating event in accordance with the information contained in the control signal, in order to have the desired electrical effect on the display segments or matrix element rows and columns of the display laminates of the display units, in order to change the display status.

14. An arrangement in accordance with claim 13, wherein each display segment or each matrix element row and column of the display laminate is connected to one control conductor, the other end of which conductor is connected to the display driver.
